(19) United States
(12) Patent Application Publication
(10) Pub. No.: US 2012/0216036 A1
(43) Pub. Date: Aug. 23, 2012

(54) ENCRYPTION METHODS AND SYSTEMS

(75) Inventors: Magued Barsoum, Framingham, MA (US); Tong Zhu, Bedford, MA (US)

(73) Assignee: GENERAL DYNAMICS C4 SYSTEMS, INC., Scottsdale, AZ (US)

(21) Appl. No.: 13/400,481

(22) Filed: Feb. 20, 2012

Related U.S. Application Data
(60) Provisional application No. 61/444,146, filed on Feb. 18, 2011.

(51) Int. Cl. H04L 9/00

(52) U.S. Cl. 713/160

(57) ABSTRACT

Systems and methods are described for securely transmitting data in a mesh network. The method includes: performing on a processor, assembling a header with a recipient address, wherein the recipient address designates an encryption endpoint; associating encrypted data with the header; and presenting a packet for transmittal on the mesh network, wherein the packet includes the header and the encrypted data.

### CROSS-REFERENCES TO RELATED APPLICATIONS

This patent application claims priority to U.S. Provisional Patent Application Ser. No. 61/444,146 filed Feb. 18, 2011 which is incorporated herein by reference in its entirety.

### TECHNICAL FIELD

The present disclosure generally relates to secure data transmission, and more particularly relates to encryption of data over a communications network.

### BACKGROUND

A multi-hop mesh network includes nodes that transmit data packets from one node to another until a destination is reached. The nodes can be fixed devices or mobile devices that communicate according to a wired or wireless protocol. The set of “hops” the data packets may take through the mesh network is constantly changing as multi-hop mesh networks constantly adapt their data packet routing based on congestion and changes in the network.

For security purposes, multi-hop mesh networks use a hop-by-hop encryption architecture. In this architecture, packets are decrypted and re-encrypted at every hop. This encryption architecture renders the data packets secure for a brief moment at every hop in the mesh network. However, a security compromise in any node in the mesh network exposes all the traffic in the network to an attacker. In addition, physical security requirements that are possible at the end nodes may also be required to be applied to intermediate nodes, which is often not possible since many such nodes are unattended. Moreover, as the path that the data packets take through the nodes changes, mesh nodes need to recompute keys between neighbor nodes. This computation is expensive and can cause significant latencies of packets as observed by the user.

Security methods, such as IPsec have been implemented to achieve end-to-end encryption, where the packets are encrypted and decrypted at the end nodes. These methods are implemented at layer three of the Open System Interconnection (OSI) model. This presents a number of challenges. When decryption is at layer three, every node within the mesh network must be manually configured with the Internet Protocol (IP) address of every other node. In a five node network, every node would need to be configured with four IP addresses, for a total of twenty IP addresses to be configured. In a 100 node network, every node would need to be configured with 99 IP addresses, for total of 99,000 IP addresses to be configured. This approach is clearly not scalable and renders many of the benefits of a mesh network useless.

When packets are encrypted at layer three of the OSI model, layer two remains vulnerable to many security attacks such as Address Resolution Protocol (ARP) poisoning and network topology discovery. To remedy the security vulnerabilities, layer two hop-by-hop encryption may be added to the existing layer three end-to-end encryption. However, this presents another set of challenges. Every packet is then encrypted twice. This requires double the processing power in every node and doubles the latency to establish a session at every node. This results in generally poor performance and more expensive and physically larger mesh points.

As a result, it is desirable to provide methods and systems for encrypting data according to an end-to-end architecture. Other desirable features and characteristics will become apparent from the subsequent detailed description and the appended claims, taken in conjunction with the accompanying drawings and this background of the invention.

### BRIEF SUMMARY

According to various exemplary embodiments, systems and methods are described for securely transmitting data in a mesh network. The method includes: performing on a processor, assembling a header with a recipient address, wherein the recipient address designates an encryption endpoint; associating encrypted data with the header; and presenting a packet for transmittal on the mesh network, wherein the packet includes the header and the encrypted data.

Other embodiments, features and details are set forth in additional detail below.

### BRIEF DESCRIPTION OF THE DRAWINGS

The present invention will hereinafter be described in conjunction with the following figures, wherein like numerals denote like elements, and

FIG. 1 is a diagram illustrating a network that includes security methods and systems in accordance with exemplary embodiments;

FIG. 2 is block diagram illustrating network nodes of the network that include security systems in accordance with exemplary embodiments;

FIG. 3 is a block diagram illustrating a data packet that is transmitted according to the security methods and system in accordance with exemplary embodiments; and

FIGS. 4A and 4B are flowcharts illustrating security methods in accordance with exemplary embodiments.

### DETAILED DESCRIPTION

The following detailed description of the invention is merely example in nature and is not intended to limit the invention or the application and uses of the invention. Furthermore, there is no intention to be bound by any theory presented in the preceding background or the following detailed description. As used herein, the term “module” refers to any hardware, software, firmware, electronic control component, processing logic, and/or processor device, individually or in any combination, including, without limitation: an application specific integrated circuit (ASIC), an electronic circuit, a processor (shared, dedicated, or group) and memory that executes one or more software or firmware programs, a combinational logic circuit, and/or other suitable components that provide the described functionality.

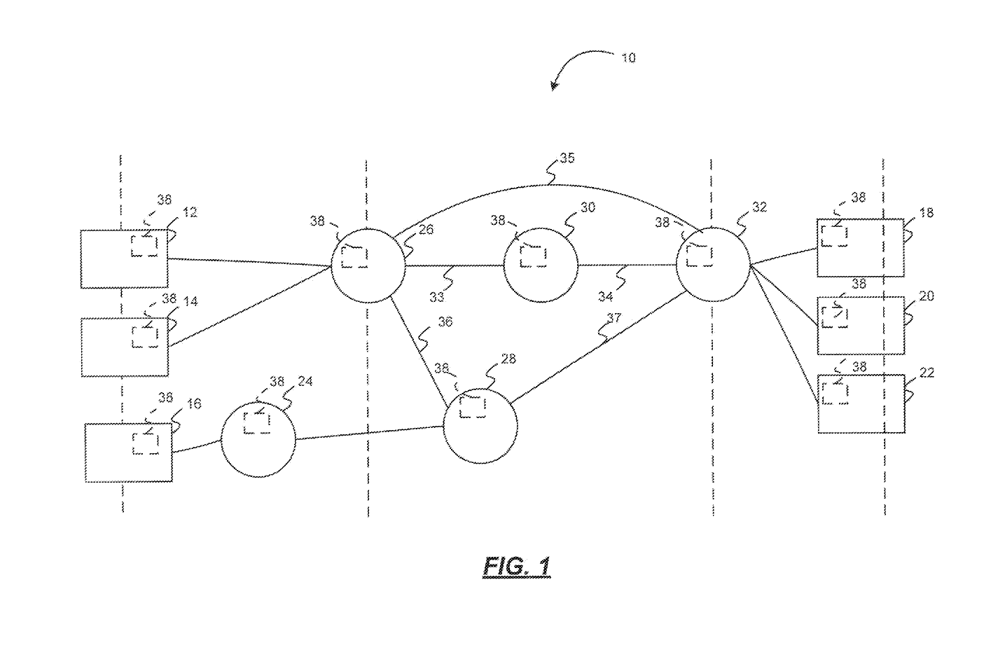

Turning now to the figures and with initial reference to FIG. 1, an exemplary mesh network 10 for providing communications between one or more devices 12-22 through one or more nodes 24-32 is shown to include a security system in accordance with various embodiments. Although the figures shown herein depict an example with certain arrangements of elements, additional intervening elements, devices, features, or components may be present in actual embodiments. It should also be understood that FIG. 1 is merely illustrative and may not be drawn to scale.

Each device 12-22 of the exemplary mesh network 10 may be a fixed or a mobile device that communicates data according to one or more networking protocols. Each node 24-32 is an intermediate device that may similarly be a fixed or a mobile device that communicates data according to one or more networking protocols. The data can be communicated from one device 12-16 to another device 18-22 through one or more dynamic paths 33-37 of nodes 24-32. For example, path 33 includes data being communicated from node 26 to node 30. Path 34 includes data being communicated from node 30 to node 32. Path 35 includes data being communicated from node 26 to node 32. Path 36 includes data being communicated from node 26 to node 28. Path 37 includes data being communicated from node 28 to node 32. As can be appreciated, the paths 33-37 may be added, deleted, or modified as the nodes 24-32 enter and exit the mesh network 10 or due to traffic congestion at various nodes within the mesh network 10.

The devices 12-22 and nodes 24-32 each include a security module 38 in accordance with exemplary embodiments. As can be appreciated, the mesh network 10 may include nodes without the security module 38. In this case, these nodes may not eligible for secure data communication.

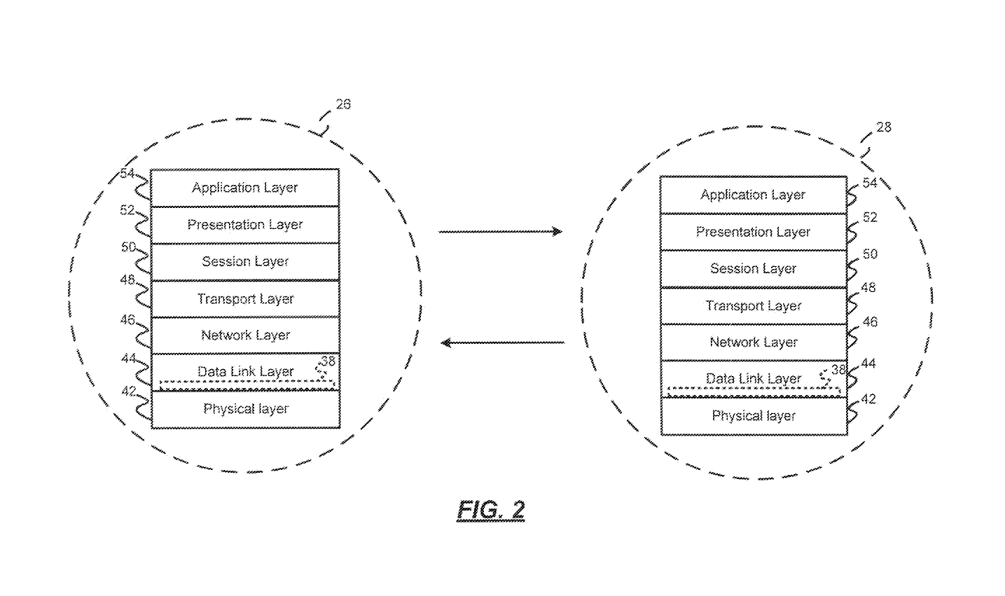

Each security module 38 transmits data according to a secure end-to-end protocol using one or more encryption/decryption methods. In various embodiments, the secure end-to-end protocol is implemented in layer two of the Open System Interconnection (OSI) model. More specifically, as shown in the example FIG. 2, the OSI model is commonly known to include seven layers: a physical layer 42, a data link layer 44, a network layer 46, a transport layer 48, a session layer 50, a presentation layer 52, and an application layer 54. Each layer 42-54 includes a set of protocols to enable the communication between nodes 26, 28. Layer two of the OSI model is also referred to as the data link layer 44. The data link layer 44 typically includes protocols that manage an error-free transfer of data packets from one node to another over the physical layer, allowing layers above it to assume virtually error-free transmission over the link. The data link layer 44 also maintains logical links for subnets, so that subnets can communicate with the mesh network 10. Although the protocols of the data link layer 44 are typically between adjacent nodes 24-32, the security methods and systems of the present disclosure enable the secure protocol to be end-to-end as opposed to hop-by-hop.

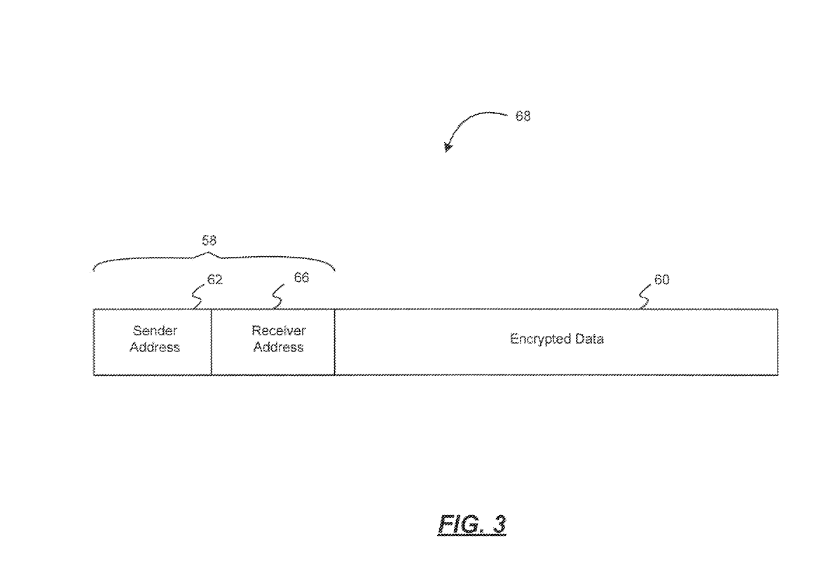

For example, the data link layer 44 includes the security module 38. The security module 38 performs one or more security methods to encrypt data, transmit the data, and decrypt the data. The security methods encrypt the data, transmit the data, and decrypt the data in an end-to-end manner by associating a header 58 (see, FIG. 3) with each packet of the data 60 to be communicated. As shown in FIG. 3, the header 58 includes a sender address 62, and a recipient address 66. The addresses 62, 66 can be, for example, a Media Access Control (MAC) address (e.g., that is determined by a media access control sub-layer of the data link layer 44) or other address. The data is encrypted and decrypted according to one or more encryption and decryption methods. As can be appreciated, any encryption/decryption method is contemplated to be within the scope of the invention. The encryption method is performed based on a key that is determined according to a key exchange protocol. For example, the Diffie-Hellman (DH) key agreement protocol can be used to determine an encryption key. The encryption key is then used by the encryption method to encrypt the data 60.

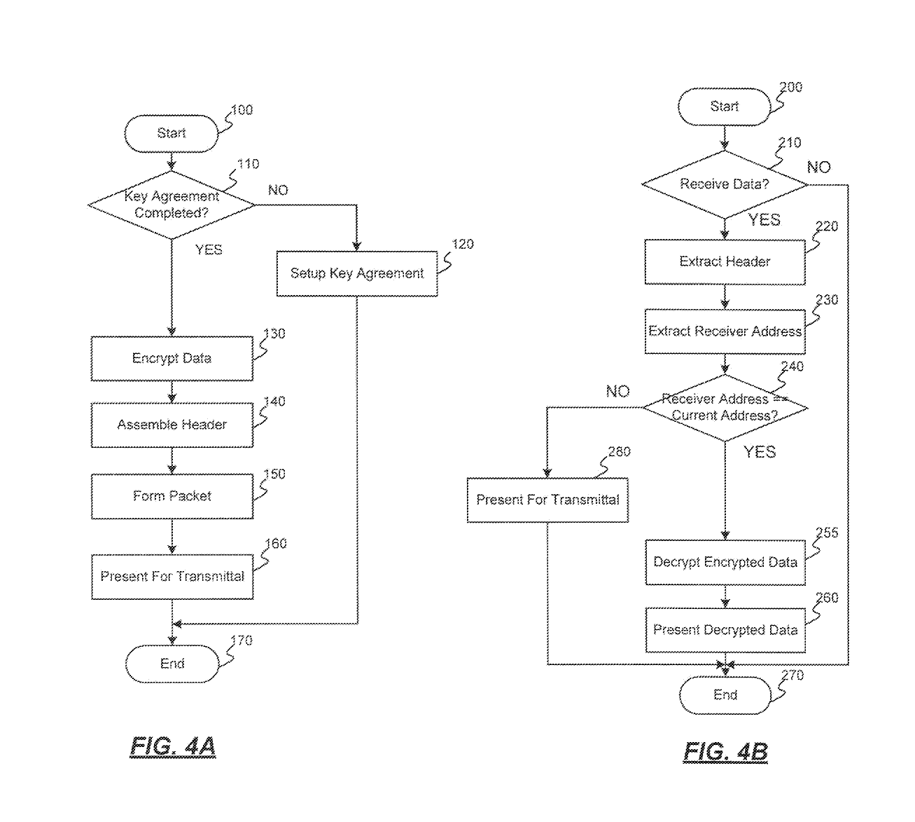

Referring now to FIGS. 4A and 4B, and with continued reference to FIGS. 1-3, flowcharts illustrate security methods that can be performed by the security module 38 of FIGS. 1 and 2 in accordance with the present disclosure. As can be appreciated in light of the disclosure, the order of operation within the methods is not limited to the sequential execution as illustrated in FIGS. 4A and 4B, but may be performed in one or more varying orders as applicable and in accordance with the present disclosure.

FIG. 4A illustrates an encryption method in accordance with exemplary embodiments. The encryption method may be scheduled to run based on predetermined events (e.g., when data is to be transmitted), and/or can run continually at predetermined intervals during operation of the corresponding node 24-32 or device 12-22.

The method may begin at 100. It is determined whether the key exchange has occurred at 110. If the key exchange has not occurred at 110, the key agreement is set up between the sender device 12 and the recipient device 18 at 120 and the method may end at 170.

If, however, the key exchange has occurred at 110, the data is encrypted according to an encryption method and based on the encryption key at 130. The header 58 is assembled based on the sender address 62 (e.g., the device's address), and the recipient addresses 66 at 140. The header 58 and the encrypted data 60 are assembled into a packet 68 at 150. The packet 68 is presented for transmittal, for example, to the physical layer 42 (see FIG. 2) at 160. Thereafter, the method may end at 170.

FIG. 4B illustrates a decryption/transmit method in accordance with exemplary embodiments. The decryption/transmit method may be scheduled to run based on predetermined events (e.g., when data is received), and/or can be run continually at predetermined intervals during operation of the corresponding node 24-32 or device 12-22.

The method may begin at 200. It is determined whether data is received at 210. If data is received at 210, the method may end at 280.

If, however, data is received at 210, the header 58 is extracted from the packet 68 at 220. The recipient address 66 is extracted from the header 58 at 230. If the recipient address 66 is the current device's address at 240, the decryption method is performed on the encrypted data 60 in the packet 68 based on the exchanged encryption key at 250. The decrypted data is presented to, for example, the network layer 46 for further processing at 260. Thereafter, the method may end at 270.

If, however, the recipient address 66 is not the current device's address at 240, the packet 68 is not decrypted rather, it is presented to, for example, the physical layer 42, for transmittal to the next node 24-32 or device 18-22 at 280. Thereafter, the method may end at 270.

As can be appreciated, one or more aspects of the present disclosure can be included in an article of manufacture (e.g., one or more computer program products) having, for instance, computer usable media. The media has embodied therein, for instance, computer readable program code means for providing and facilitating the capabilities of the present disclosure. The article of manufacture can be included as a part of a computer system or provided separately.

Additionally, at least one program storage device readable by a machine, tangibly embodying at least one program of instructions executable by the machine to perform the capabilities of the present disclosure can be provided.

While at least one example embodiment has been presented in the foregoing detailed description of the invention, it should be appreciated that a vast number of equivalent variations exist. It should also be appreciated that the embodiments described above are only examples, and are not intended to limit the scope, applicability, or configuration of the invention in any way. Rather, the foregoing detailed description will provide those skilled in the art with a convenient road map for implementing various examples of the invention. It should be understood that various changes may be made in the function and arrangement of elements described in an example embodiment without departing from the scope of the invention as set forth in the appended claims and their legal equivalents.

What is claimed is:

1. A method of securely transmitting data in a mesh network, comprising:
performing on a processor,
assembling a header with a recipient address, wherein the recipient address designates an encryption endpoint;
associating encrypted data with the header; and
presenting a packet for transmittal on the mesh network, wherein the packet includes the header and the encrypted data.

2. The method of claim 1 wherein the assembling, the associating, and the presenting are performed within layer two of an Open System Interconnection model.

3. The method of claim 1 wherein the assembling further comprises assembling the header with a sender address.

4. The method of claim 1 further comprising encrypting data according to an encryption method to result in the encrypted data.

5. The method of claim 1 further comprising exchanging an encryption key with an end receiver based on a key exchange method.

6. The method of claim 1 further comprising transmitting the packet through the mesh network.

7. The method of claim 6 further comprising:
receiving the packet at an end node of the mesh network; and
processing the packet to determine the header and the encrypted data; and
decrypting the encrypted data based on the header.

8. The method of claim 7 wherein the receiving, the processing, and the decrypting are performed within layer two of an Open System Interconnection model.

9. The method of claim 1 further comprising:
receiving the packet at an intermediate node of the mesh network; and
processing the packet to determine the header; and
presenting the packet for transmittal to a next node based on the header.

10. The method of claim 9 wherein the receiving, the processing, and the decrypting are performed within layer two of an Open System Interconnection model.

11. A system for securely transmitting data in a mesh network, comprising:
a node; and
a security module within the node that assembles a header with a recipient address wherein the recipient address designates an encryption endpoint, that associates encrypted data with the header, and that presents a packet for transmittal on the mesh network, wherein the packet includes the header and the encrypted data.

12. The system of claim 11 wherein the node has a plurality of communication layers, and wherein the security module is implemented at a data link layer of the plurality of layers.

13. The system of claim 11 wherein the security module further assembles the header with a sender address.

14. The system of claim 11 wherein the security module encrypts data according to an encryption method to generate the encrypted data.

15. The system of claim 11 wherein the security module exchanges an encryption key with an end receiver based on a key exchange method.

16. The system of claim 11 wherein the node is an end node, and wherein the security module receives a second packet, processes the second packet to determine a header and encrypted data; and decrypts the encrypted data based on the header.

17. The system of claim 11 wherein the node is an intermediate node, and wherein the security module receives a second packet, processes the packet to determine the header, and presents the packet for transmittal to a next node based on the header.

18. A computer program product for securely transmitting data in a mesh network, comprising:
a tangible storage medium readable by a processing circuit and storing instructions for execution by the processing circuit for performing a method comprising:
assembling a header with a recipient address, wherein the recipient address designates an encryption endpoint;
associating encrypted data with the header; and
presenting a packet for transmittal on the mesh network, wherein the packet includes the header and the encrypted data.

19. The computer program product of claim 18 wherein the assembling, the associating, and the presenting are performed within layer two of an Open System Interconnection model.

20. The computer program product of claim 18 further comprising exchanging an encryption key with the encryption endpoint based on a key exchange method, and wherein the encrypted data is encrypted based on the encryption key.
